(19) United States
(12) Patent Application Publication
(10) Pub. No.: US 2025/0004810 A1
(43) Pub. Date: Jan. 2, 2025

(54) INFRASTRUCTURE-INDEPENDENT SCALING OF HYPERCONVERGED COMPUTING NODES

(71) Applicant: Nutanix, Inc., San Jose, CA (US)

(72) Inventors: Veeral SHAH, Pune (IN); Prasad JOSHI, Pune (IN); Prathamesh Vasant CHAVAN, Gurgaon (IN); Nitin PARAB, Palo Alto, CA (US)

(73) Assignee: Nutanix, Inc., San Jose, CA (US)

(21) Appl. No.: 18/217,438

(22) Filed: Jun. 30, 2023

(51) Int. Cl. G06F 9/455

(52) U.S. Cl. CPC G06F 9/45558; G06F 9/45541; G06F 2009/45579

(57) ABSTRACT

Methods, systems, and computer program products for expandible/contractible computing. A configurator establishes a computing environment having a storage pool formed using a common address space across storage located on multiple computing nodes. One or more instances of a first type of computing node having both a virtualization storage controller and any number of user virtual machines is situated in the computing environment. Instances of the first type of computing node are highly performant so as to handle arbitrarily large workloads. A second type of computing node having lightweight characteristics is instanced into the computing environment and interconnected to the one or more instances of the first type of computing node. The second type of computing node runs a virtualization storage controller but does not run any user virtual machines. Environment-specific variations of the virtualization storage controller can be configured dynamically and in real-time, based on characteristics of the computing environment.

### TECHNICAL FIELD

This disclosure relates to hyperconverged computing clusters, and more particularly to techniques for dimension-independent scaling of hyperconverged infrastructure (HCI) computing nodes.

### BACKGROUND

Computing on hyperconverged infrastructure has become ubiquitous. The ease with which additional nodes can be added to a hyperconverged computing cluster (e.g., an on-premises computing cluster or a cloud-based computing cluster or a hybrid computing cluster) has greatly reduced the difficulties and expense of designing and maintaining a computing cluster. This is because adding an additional hyperconverged infrastructure node (HCI node) to a pre-existing hyperconverged computing cluster has the highly desirable effect of concurrently adding computing capabilities in three computing dimensions.

Specifically, in a first dimension, additional computing power is added due to additional CPUs of the HCI node; in a second dimension, additional networking bandwidth is provided due to the additional networking interfaces of the HCI node; and in the third dimension, additional storage capacity is provided due to the addition of the storage devices of the added HCI node. While adding computing capabilities in all three dimensions has proven to be extremely convenient for ongoing management of a computing facility, it sometimes has the unwanted consequence of adding all three of these computing capabilities in all three dimensions in more-or-less equal measures. Accordingly, it sometimes happens that much more additional storage is needed even though very little additional CPU power is needed-leading to overspent, and possibly wasted capital expenditures.

One approach to being able to add more additional storage even though very little additional CPU power is needed is to custom-configure the hardware of an HCI node that has a lot of additional storage onto an HCI node that has very little CPU power. While this is sometimes possible (e.g., in the situation that a particular customer controls procurement of HCI nodes such as in a fully-on-premises configuration), it sometimes happens that, especially in a cloud-based computing cluster setting (e.g., involving a computing cluster fully deployed on cloud infrastructure) or in a hybrid computing cluster setting (e.g., involving a computing cluster that is partially deployed on cloud infrastructure and partially deployed using on-premises infrastructure) it becomes impossible or impractical since the selection of HCI nodes is limited to whatever the cloud vendor is offering.

The constraint where the configuration of selectable HCI nodes is limited to only whatever types or configurations of nodes the cloud vendor is offering has far reaching implications. For example, the cloud vendor may offer only super high performance nodes as bare metal nodes—and those super high performance nodes command a price premium. In such a situation, provisioning a super-high performance bare metal node might end up provisioning far more computing power (e.g., expensive CPUs) and far more expensive memory (e.g., hundreds of gigabytes of memory, terabytes of memory, etc.) than is needed for the workload, which is extremely wasteful and cost inefficient. Moreover, mere availability of a bare metal node is sometimes non-deterministic (e.g., depending on the infrastructure situation of a particular cloud provider). Therefore, what is needed is a way to flexibly add HCI nodes that are ‘right sized’ based upon then current workload and/or workload expansion needs.

Unfortunately, prior approaches exhibit one or more of the foregoing deficiencies. Therefore, what is needed is a technique or techniques that address flexibly deploying ‘right sized’ hyperconverged infrastructure computing nodes.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for infrastructure-independent scaling of hyperconverged computing nodes, which techniques advance the relevant technologies to address technological issues with legacy approaches. More specifically, the present disclosure describes techniques used in systems, methods, and in computer program products for dynamically configuring hypervisor-less nodes in hyperconverged infrastructure computing clusters. Certain embodiments are directed to technological solutions for dimension-independent deployment of hyperconverged infrastructure computing nodes.

The disclosed embodiments modify and improve over legacy approaches. In particular, the herein-disclosed techniques provide technical solutions that address the technical problems attendant to flexibly deploying hyperconverged infrastructure computing nodes. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication. For example, when performing computer operations that address the various technical problems underlying the deployment of hyperconverged infrastructure computing nodes, both memory usage and CPU cycles demanded are significantly reduced as compared to the memory usage and CPU cycles that would be needed but for practice of the herein-disclosed techniques. Moreover, when deploying hyperconverged infrastructure computing nodes in accordance with the disclosures herein, oversizing of computing infrastructure is eliminated or curtailed.

The ordered combination of steps of the embodiments serve in the context of practical applications that perform steps for providing infrastructure-independent scaling of hyperconverged computing nodes efficiently. As such, the herein-disclosed techniques for providing infrastructure-independent scaling of hyperconverged computing nodes overcome long-standing yet heretofore unsolved technological problems associated with flexibly deploying hyperconverged infrastructure computing nodes, which problems arise in the realm of computer systems.

Many of the herein-disclosed embodiments for providing dimension-independent scaling of hyperconverged infrastructure computing nodes are technological solutions pertaining to technological problems that arise in the hardware and software arts that underlie hybrid computing clusters. Aspects of the present disclosure achieve performance and other improvements in peripheral technical fields including, but not limited to, high-performance computing and computing cluster management.

Some embodiments include a sequence of instructions that are stored on a non-transitory computer readable medium. Such a sequence of instructions, when stored in memory and executed by one or more processors, causes the one or more processors to perform a set of acts for providing infrastructure-independent scaling of hyperconverged computing nodes.

Some embodiments include the aforementioned sequence of instructions that are stored in a memory, which memory is interfaced to one or more processors such that the one or more processors can execute the sequence of instructions to cause the one or more processors to implement acts for providing infrastructure-independent scaling of hyperconverged computing nodes.

In various embodiments, any combinations of any of the above can be organized to perform any variation of acts for dynamically configuring hypervisor-less nodes in hyperconverged infrastructure computing clusters, and many such combinations of aspects of the above elements are contemplated.

A method of forming a controller virtualized machine node from a hyperconverged infrastructure (HCI) node, the method comprising: (1) identifying dependencies of the HCI node on hypervisor functions and other service dependencies; (2) mapping the identified hypervisor functions and other service dependencies to one or more of, (a) cloud provider facilities or (b) initialization code for the cloud provider facilities; (3) creating, based at least in part on the mapping, a modified hyperconverged infrastructure (HCI) node. The foregoing method can include (4) hibernating the hypervisor of the hyperconverged infrastructure (HCI) node; and (5) initiating execution of the modified hyperconverged infrastructure (HCI) node.

Further, disclosed herein are variations of mixed node-type computer systems (e.g., variations of computing clusters) having two or more controller virtualized machines (CVMs) hosted by two computer nodes that are configured differently (e.g., one node with a hypervisor and one node without a hypervisor). Some differently-configured nodes that form the mixed node-type computer system can comport with (1) two nodes, each of which is a hyperconverged infrastructure (HCI) node that hosts at least one hypervisor and at least one controller virtualized machine; and (2) a further node that is controller virtualized machine only node (CVM-only node), wherein the hyperconverged infrastructure nodes and the CVM-only node each have respective storage devices that are organized into a common address space, and wherein the CVM-only node comprises a virtualization storage controller that is configured to operate in absence of a hypervisor.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1A1, FIG. 1A2, FIG. 1A3, and FIG. 1A4 exemplify deployment configurations that include configuring one or more dynamically-configured hypervisor-less nodes to form a hyperconverged infrastructure computing cluster, according to some embodiments.

FIG. 2 depicts a deployment configuration technique that exemplifies an approach for dynamically configuring a hypervisor-less node into a hyperconverged infrastructure computing cluster, according to some embodiments.

FIG. 3 shows a state chart to illustrate one possible HCI computing cluster expansion and contraction technique as used in systems that integrate dynamically-configured hypervisor-less nodes into hyperconverged infrastructure computing clusters, according to an embodiment.

FIG. 4 depicts a system that implements a deployment configuration technique for dynamically configuring hypervisor-less nodes into a cloud-based hyperconverged infrastructure computing cluster, according to some embodiments.

FIG. 5 illustrates a series of computing cluster configuration state transitions that occur in systems that dynamically configure hypervisor-agnostic nodes using public cloud computing infrastructure, according to some embodiments.

FIG. 6A illustrates a small computing cluster configuration technique as used in systems that dynamically configure hypervisor-agnostic nodes into an HCI computing cluster using public cloud computing infrastructure, according to some embodiments.

FIG. 6B1 illustrates a disaster recovery standby site configuration technique as used in systems that dynamically configure hypervisor-agnostic nodes into an HCI computing cluster using public cloud computing infrastructure, according to some embodiments.

FIG. 6B2 illustrates a disaster failover site configuration technique, according to some embodiments.

FIG. 7A, FIG. 7B, FIG. 7C, and FIG. 7D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems for flexibly deploying hyperconverged infrastructure computing nodes. These problems are unique to, and may have been created by, various computer-implemented methods for deploying hyperconverged infrastructure computing nodes in the context of hybrid computing clusters. Some embodiments are directed to approaches for providing dimension-independent scaling of hyperconverged infrastructure computing nodes. The accompanying figures and discussions herein present example environments, systems, methods, and computer program products for dynamically configuring hypervisor-less nodes in hyperconverged infrastructure computing clusters.

### Overview

Computing clusters have evolved from purely on-premises computing clusters to include hybrid computing clusters where some nodes of a computing cluster are deployed in an on-premises setting and some nodes of the computing cluster are deployed in the cloud. More recently, computing clusters can be deployed using purely cloud-provided (e.g., bare metal) infrastructure. There is a commercial need to support all of the foregoing deployment models. Moreover there is a need to facilitate ease of expansion and/or migration into any one or more of the foregoing deployment models. Disclosed hereunder are various techniques that enable enterprises to run all or parts of the enterprise's computing clusters using cloud infrastructure (e.g., major public cloud providers). Individual nodes or groups of nodes of such computing clusters can be formed of bare metal instances (e.g., as provided by Amazon Web Services (AWS)) or dedicated hosts (e.g., as provided by Microsoft under the Azure brand name). Additionally or alternatively, individual nodes or groups of nodes of such computing clusters can be formed of nearly any hardware infrastructure that can host software components of a virtualization system.

### Virtualization System Software Component Deployment

Various virtualization system software components can be configured to integrate with a cloud provider's software offerings (e.g., operating system (OS) offerings, hypervisor offerings, etc.) and the cloud provider's hardware (e.g., networking componentry). Such integration offers many advantages to the enterprise. For example, given the various scalability options as herein mentioned, the enterprise has a chance to avail of any existing cloud provider accounts, existing private networks, existing VPNs, etc. As such, administrators and users of the enterprise's deployment can experience extreme flexibilities in the makeup of their computing cluster(s) without having to procure, deploy, manage, maintain, and retire enterprise-captive datacenter infrastructure.

### Software License Mobility

In addition to the foregoing advantages and flexibilities, enterprises can avail themselves of their existing software licenses. In some situations, software licenses can float in and across and by and between any nodes of a hybrid computing cluster, thus facilitating utterly flexible license mobility between private computing nodes situated in “on-prem” settings and nodes situated on public cloud infrastructure. In some cases, an enterprise can float in and across and by and between any nodes of a hybrid computing cluster, even under (1) “pay as you go” subscription contracts and/or (2) multi-year commitment contracts.

### Cloud-Agnostic Deployments

In addition to the foregoing advantages and flexibilities, enterprises can fully exploit any existing investments in whatever selected public cloud provider(s) have been selected by the enterprise. Moreover, using the herein-disclosed techniques, workloads can migrate into and across and by and between any nodes of a hybrid computing cluster in a manner that is cloud provider-agnostic. Moreover, the foregoing integrations as mentioned above and as further discussed below, provides the enterprise's administrators an easy-to-manage “on-ramp” to be able to move to a newly-selected public cloud environment, yet without the need to re-architect or refactor their applications. In some settings a hybrid computing cloud can be deployed in a cloud-agnostic manner-even across multiple public clouds. This allows the enterprise to take advantage of (or avoid) so called, “spot pricing” or “surge pricing” by enabling workload mobility between differing public cloud infrastructure without requiring workload changes.

### Virtualization System Component Architecture

Clustered virtualization systems are composed of interconnected computing nodes, any/all of which may include a hypervisor and a computing cluster controller that runs on top of the hypervisor as a virtual machine. In some cases, such clustered virtualization systems are configured with a virtualization storage controller that serves to amalgamate the various node-local storage devices into a single computing cluster-wide shared storage facility that is organized into a common storage address space across the nodes of the computing cluster such that any node can address any portion of the shared storage using the addresses that make up the common storage address space. In some cases, a computing cluster controller, or more particularly, the plurality of computing cluster controllers of the various nodes of the computing cluster are configured such that (1) any storage address access request raised by any node to access any address of the shared common address space is processed locally by the receiving node using node-local storage device(s), or (2) the storage address access request is forwarded (e.g., over a network) to a different node where the actual physical storage corresponding to the referenced storage address resides.

### Architecture of Storage-Only Nodes

The foregoing mechanism allows the nodes of the computing cluster to be able to share a common address space across the nodes of the computing cluster such that any node can address any portion of the share storage is facilitated by a virtualization storage controller. In some cases, a computing node that has a lot of storage capacity, but limited computing capacity, is added to a computing cluster. Such a node can serve as a storage-only node. The node's computing capacity, even though limited, is sufficient to handle storage access requests (e.g., either by locally handling the storage access request, or by forwarding the storage access request), however the limited computing capacity is expected to be insufficient to handle large workloads (e.g., a user virtual machine (UVM) or a user workload). Therefore, user processes (e.g., UVMs or user workloads) are disallowed on a storage-only node. The aforementioned controller virtual machine or its agents enforce this regime where user processes, in particular user virtual machines are disallowed on storage-only nodes.

In spite of the limitations of this regime (i.e., where user processes are disallowed), such a storage-only node can process any storage access request from any node of the computing cluster. The fact that user processes are disallowed on a storage-only node means that a storage-only node can be configured with a minimum of virtualization system and/or operating system services. In some cases, a storage-only node can be configured as a CVM-only node where the CVM is configured to process any storage access request from any node of the computing cluster, yet without needing a hypervisor at all. In further cases, a storage-only node can be configured as a CVM-only node where the CVM is configured to process any storage access request from any node of the computing cluster, yet without needing a hypervisor and without needing a guest operating system or, in some cases, without a guest operating system. This is possible because (1) given the a priori known functions to be provided by the CVM of a storage-only node, no virtualization layer (e.g., hypervisor layer) is needed, and because (2) any operating system functions and/or device driver functions as might be needed to implement the a priori known functions can be integrated into the CVM before or upon deployment of the CVM onto the storage-only node. In some situations, a CVM can be deployed as an executable container. Moreover, there are some situations where a CVM can run as an executable container that includes needed components of an OS. Further, there are some situations where all or portions of an OS kernel runs on a worker node that is configured to be able to support a CVM. Still further, there are some situations where CVM components are packaged to run as one or more containers on one or more nodes, each of which has respective sets of needed components of an OS.

Further details regarding handling of a virtualization system in an executable container are described in U.S. patent application Ser. No. 15/233,808 titled “AUTOMATIC APPLICATION MIGRATION ACROSS VIRTUALIZATION ENVIRONMENTS” filed on Aug. 10, 2016, which is hereby incorporated by reference in its entirety.

As can be seen, implementation of a storage pool formed using a common address space across storage located on multiple computing nodes underlies a variety of different configurations of heterogeneous nodes (e.g., storage-only nodes, compute-only nodes, service-only nodes, etc.). Strictly as one example, a first type of computing node can be configured to host both a virtualization storage controller and one or more UVMs, wherein the UVMs interacts with the virtualization storage controller to access the storage pool (e.g., using addresses drawn from the aforementioned shared common address pool), whereas a second type of computing node is configured to have a virtualization storage controller but without having any user virtual machines that interact with the virtualization storage controller (e.g., to access the storage pool). Having the option to include this second type of computing node in a computing cluster offers the option to expand functionality of the computing cluster as well as to expand the functionality of the computing environment as a whole. Moreover, since this second type of computing node demands less computing power (e.g., since running UVMs are disallowed or disabled), this second type of computing node can serve as a lightweight computing node that is implemented and deployed on demand, possibly using resources available from a cloud computing vendor. Some implementation and deployment examples are discussed in further detail hereunder.

### CVM-Only Nodes in a Cloud Setting

As detailed above, a CVM of a storage-only node can be configured to run natively on a particular hardware configuration of a particular computing cluster node without reliance on any underlying hypervisor. As such, a CVM of a storage-only node can be configured to run within the cloud-provided ecosystem of AWS, or within the cloud-provided ecosystem of Azure, etc. In a first type of deployment, a cloud-configured CVM can run on a cloud-provided bare metal instance. In a second type of deployment, a cloud-configured CVM can run on a cloud-provided non-metal (e.g., EC2) instance. Strictly as an example of the first type of deployment, a CVM can run on a cloud-provided bare metal instance that is configured with or without components of a virtualization system and/or with or without components of an operating system. Strictly as an example of the second type of deployment, a CVM can run on a cloud-provided non-bare metal instance that is configured with or without a cloud-provided hypervisor and/or with or without components of a cloud-provided host operating system. Furthermore, computing nodes that comport with the first type of deployment can operate in conjunction with computing nodes that comport with the second type of deployment. In some cases, a computing cluster can be expanded by adding a single computing node or multiple computing nodes that comport with either or both the first type of deployment and/or the second type of deployment. In exemplary cases, computing nodes that comport with the second type of deployment (e.g., a CVM-only deployment) the configured nodes do instance a CVM, but do not use a hypervisor at all.

As used herein, a CVM-only node is a computer that is configured to implement a virtualization system, yet without reliance on a hypervisor.

### Example Use Cases

Given the advantages and flexibilities that inure to the existence of a CVM-only node, there are many use cases that emerge, some of which are shown and described in Table 1. These and other use cases are further shown and described as pertains to the appended figures.

TABLE 1

| Use Case Name | Use Case Description |
|---|---|
| Adding storage- | If a customer is running into storage capacity |
| only node | bottlenecks/constraints, they would |
| capabilities | want to add a node type that removes the |
| | bottleneck. If storage capacity is the |
| | limiting factor, then the customer can add |
| | a storage-only node to their existing |
| | computing cluster. If storage I/O (input/ |
| | output or IO) performance is the limiting |
| | factor, then the customer can add multiple |
| | storage-only nodes to their existing |
| | computing cluster. |
| Forming a | A computing cluster made up of all |
| computing | CVM-only nodes can serve any amount of |
| cluster to serve up | storage capacity and any amount |
| volume-as-a-service | of storage I/O. |
| (VaaS) capabilities | |
| Forming a disaster | A DR target computing cluster formed under |
| recovery | a pay-as-you-go contract or under a |
| (DR) target | minimum guaranteed service contract can |
| computing | be built using a plurality of CVM-only |
| cluster | nodes. In case of occurrence of a disaster |
| | or other reason to failover to the DR |
| | target, one or more metal instances can |
| | be added to the computing cluster to run |
| | failed-over workloads. |
| Turning a two node | A hybrid/heterogeneous computing cluster |
| installation | with two fully-configured virtualization |
| into a three | system nodes (e.g., on-prem instances) |
| node computing | and one CVM-only node can meet |
| cluster to meet | requirements of a consensus-aware 3 |
| consensus-aware 3 | node minimum This hybrid configuration is |
| node minimum | both flexible and cost effective since |
| | the cloud-hosted CVM-only node can be |
| | minimally-configured and/or shared |
| | with other tenants. |
| Configuring | HA computing specifies computing |
| for high | clusters with a minimum guarantee of 3 |
| availability | partitions. In order to guarantee node |
| (HA) by | availability for such partitions, customers |
| allocating a | can rely on non-metal instances that |
| low-cost reserved | are readily available in all regions and |
| instance (RI) | in/across all availability zones. |

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

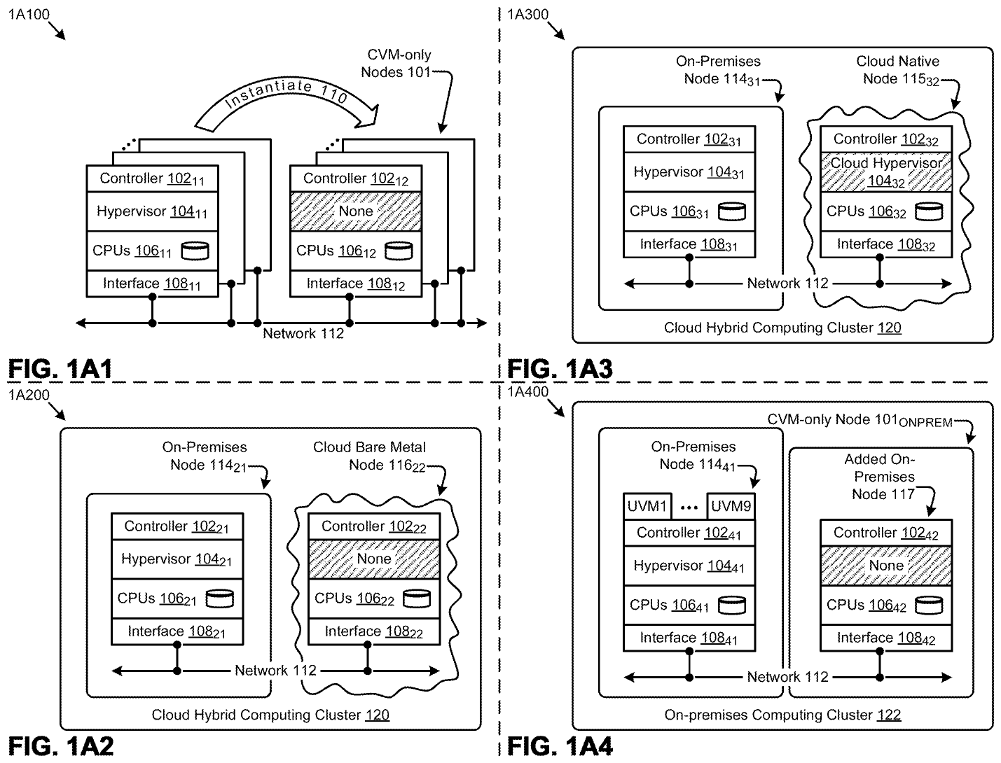

FIG. 1A1, FIG. 1A2, FIG. 1A3, and FIG. 1A4 exemplify deployment configurations that include configuring one or more dynamically-configured hypervisor-less nodes to form a hyperconverged infrastructure computing cluster. As an option, one or more variations of deployment configurations 1A100, deployment configuration 1A200, deployment configuration 1A300, and deployment configuration 1A400 or any aspect thereof may be implemented in the context of the architecture and functionality of the embodiments described herein and/or in any environment.

The four configurations are being presented on the same sheet for comparison purposes. Specifically, shown are four example configurations that are applicable and optimized in the face of capabilities needed in a deployment. As an overview, FIG. 1A1 shows a use case where a three node computing cluster is expanded into a six node computing cluster where the additional three nodes are hypervisor-less nodes; FIG. 1A2 shows a cloud hybrid computing cluster formed when a cloud-provided bare metal node is added to an on-premises computing cluster; FIG. 1A3 shows a cloud hybrid computing cluster formed when a cloud-provided native node (e.g., non-bare metal node) is added to an on-premises computing cluster; and FIG. 1A4 shows support for user VMs in an on-premises computing cluster.

To further explain, FIG. 1A1 illustrates a configuration that includes three or more CVM-only nodes. In one deployment, the foregoing three or more CVM-only nodes are added to an existing computing cluster. In most embodiments, the existing computing cluster is able to configure (e.g., via instantiate 110) its own extension. In the specific embodiment of FIG. 1A1, the existing computing cluster comprises three nodes, each having its own CPUs and node-local storage (e.g., CPUs 106₁₁), its own hypervisor (e.g., hypervisor 104₁₁) its own controller (e.g., controller 102₁₁), and its own interface (e.g., interface 108₁₁) to a network (e.g., network 112). However, there are many alternative configurations. Moreover, a multi-node HCI computing cluster can be dynamically expanded by, in response to a request or other indication, expanding the multi-node HCI computing cluster by adding a CVM-only node to the multi-node HCI computing cluster. Similarly, a multi-node HCI computing cluster can be dynamically contracted by, in response to a further request or indication, contracting the multi-node HCI computing cluster by reverting the CVM-only node back to an HCI node of the multi-node HCI computing cluster. In some situations, this contraction can be carried out by reclaiming (and/or decommissioning) any one or more computing nodes that have a virtualization storage controller (but not having any UVMs that interact with the virtualization storage controller that accesses the storage pool). In some cases, various acts of reclaiming results in moving a node that is hosted in a cloud infrastructure onto (or back to) a node of an on-premises cluster.

### Storage-Only Extensions

A storage-only extension involving one or more storage-only nodes (e.g., CVM-only node 101) can be created to support any amount of storage and any rate or amount of I/O (input/output or IO) operations per second (IOPS). As such nodes of a storage-only computing cluster can be configured for predictable storage subsystem performance by (1) sizing the number and capabilities of the storage-only nodes, and (2) disabling support for user virtual machines.

Such a deployment is extremely cost efficient, at least in that the CVM-only nodes that comprise the storage-only extension can be sized (e.g., for CPU power and storage capacity) based on a measured storage workload. Moreover, while each of the CVM-only nodes have their own CPUs (e.g., CPUs 106₁₂) and node local storage, and while each of the CVM-only nodes have their own controller (e.g., controller 102₁₂), and while each of the CVM-only nodes have their own interface (e.g., interface 108₁₂) to a network (e.g., network 112), none of the nodes that comprise the storage-only extension have a hypervisor. This is shown by the diagonal cross-hatching between CPUs 106₁₂ and controller 102₁₂. Configurations where there is no hypervisor are cost effective, at least inasmuch as licensing fees for a hypervisor are avoided.

In some deployments, a configuration with a plurality of CVM-only nodes can be deployed with storage that is organized into a common address space that is distinct from the common address spaces that underly other computing clusters that might be interfaced to network 112.

The foregoing deployment of FIG. 1A1 is comprised of multiple nodes. Some of such nodes could be situated on-premises, while some others of such nodes can be situated in a cloud. This miscibility of nodes offers up a panoply of hybrid cloud configurations, some of which are shown and discussed hereunder. As strictly one example hybrid cloud configuration, FIG. 1A2 shows a cloud hybrid computing cluster 120 formed when a cloud bare metal node 116₂₂ is added to an on-premises computing cluster. As shown, while the on-premises node 11421 has its own CPUs (e.g., CPUs 106₂₁) and node local storage and its own interface (e.g., interface 108₂₂) to a network (e.g., network 112), and while the on-premises node has its own controller (e.g., controller 10221) and hypervisor (e.g., hypervisor 104₂₁), and while the on-premises node has its own interface (e.g., interface 108₂₁) to a network (e.g., network 112), the cloud bare metal node 116₂₂ does not have a hypervisor. This is shown by the diagonal cross-hatching between CPUs 106₂₂ and controller 102₂₂.

A configuration such as is given by FIG. 1A2 is convenient for the computing cluster operator, at least in that a cloud bare metal node can be allocated and configured nearly instantaneously. This near instantaneous availability is to be contrasted with the much more cumbersome alternative of ordering new hardware to extend the computing cluster. Further, the configuration such is as given by FIG. 1A2 is convenient for the computing cluster operator, at least in that a cloud bare metal node can be released from allocation nearly instantaneously. This near instantaneous release and reconfiguration is to be contrasted with the much more cumbersome alternative of disposing of, or re-deploying, hardware that had previously been used to extend the computing cluster.

As is known in the art, there are alternatives to deploying a cloud bare metal node into a cloud hybrid computing cluster. One of these alternatives involves forming a cloud hybrid computing cluster 120 such as is shown in FIG. 1A3. Here, the on-premises computing cluster that includes the shown on-premises node 114₃₁ (e.g., comprising controller 102₃₁, hypervisor 104₃₁, CPUs 106₃₁, and interface 108₃₁, as shown) is extended by adding a cloud native node 11532. (e.g., comprising controller 102₃₂, an unused cloud hypervisor 104₃₂, CPUs 106₃₂, and interface 108₃₂, as shown). This type of extension, where a cloud native node is added, can be combined with the extension technique where a cloud bare metal node is added. In this manner, a cloud hybrid computing cluster can be configured to comport with nearly any sizing requirements of resources in all three dimensions.

Given the flexibilities of the foregoing, the computing cluster operator is presented with the situation where (1) the cloud hybrid configuration minimizes computing cluster cost; (2) there is a lower entry barrier to expanding a computing cluster; (3) storage capacity and performance can be guaranteed within a narrow range (e.g., to comport with a specified IOPS quality of service (QOS)); (4) a storage expansion (and contraction) path is enabled, yet without adding new computing cluster nodes; and (5) such configurations provide support for storage tiering.

In some cases, a computing cluster operator might prefer to deploy their own CVM-only node into their own on-premises computing infrastructure. This is shown in FIG. 1A4. Specifically, an on-premises computing cluster 122 is formed by multiple on-premises nodes, one of which is shown in FIG. 1A4 as on-premises node 114₄₁ (e.g., comprising controller 102₄₁, hypervisor 104₄₁, CPUs 106₄₁, and interface 108₄₁). As can be seen, a further node, specifically the shown added on-premises node 117 (e.g., comprising controller 102₄₂, CPUs 106₄₂, and interface 108₄₂), can be added to the computing cluster, and this additional on-premises node can be configured as a CVM-only node 101. As previously indicated, user VMs are disallowed on CVM-only nodes. Accordingly, the embodiment of FIG. 1A4 shows many UVMs (e.g., UVM1, . . . , UVM9) running on the on-premises node 114₄₁, whereas there are no UVMs running on the CVM-only node 101_{ONPREM}.

The flexibilities offered by the miscibility of on-prem and cloud-provided infrastructure, plus the miscibility of any number of cloud-provided bare metal nodes with any number of cloud-provided native nodes leads to many advances in techniques for exploiting the benefits. Some of these advances are described in accordance with the designated methods listed in Table 2.

TABLE 2

| Designation | Description |
|---|---|
| Method 1 | A method for configuring a CVM-only node |
| | to operate on a cloud-provided or on-prem- |
| | provided bare metal node in a computing cluster. |
| Method 2 | A method of “morphing forward” to turn an |
| | ‘ordinary’ HCl node into a cloud-native node (i.e., |
| | not bare metal) to operate as a CVM-only |
| | configuration, then “morphing back” the CVM-only |
| | node into the same computing cluster |
| | as an ‘ordinary’ HCl node. |
| Method 3 | A method of dynamically expanding and |
| | contracting a multi-node HCl computing cluster by |
| | (1) when a first set of conditions occurs, then |
| | expanding the computing cluster by adding a |
| | CVM-only node to the computing cluster; and |
| | (2) when a second set of conditions occurs, |
| | then contracting the computing cluster |
| | by destroying the CVM-only node. |

Moreover, the flexibilities offered by the miscibility of on-prem and cloud-provided infrastructure, plus the miscibility of any number of cloud-provided bare metal nodes with any number of cloud-provided native nodes leads to advances in several capability dimensions. A selection of configurations, together with their corresponding CPU capabilities, memory size, storage capacity, and network performance is shown in Table 3.

TABLE 3

| | Example | | | | |
|---|---|---|---|---|---|
| | Normalized | | | Storage | Network |
| Instance | On Demand | | Memory | (NVMe | Performance |
| Name | (hourly rate) | vCPUs | (GiB) | SSD) | (Gigabit) |
| i3.4xlarge | $1 | 16 | 122 | 2 × 1900 | Up to 10 |
| c5d.12large | $2 | 48 | 96 | 2 × 900 | 12 |
| zld.metal | $4 | 48 | 384 | 2 × 900 | 25 |
| i3en.metal | $10 | 96 | 768 | 8 × 7500 | 100 |

Any of the foregoing methods or configurations of Table 2 or Table 3 can be applied singularly or in combination. To form a computing cluster of heterogeneous nodes (e.g., a computing cluster formed of mixture of different node types). Strictly as an example, a mixed node-type computer system (e.g., computing cluster) having two or more controller virtualized machines (CVMs) can be formed by (1) at least one hyperconverged infrastructure (HCI) node that hosts at least one hypervisor and at least one controller virtualized machine; and (2) at least one controller virtualized machine only node (CVM-only node). As contemplated in the constituency of the foregoing mixed node-type computer system, each of the HCI node and the CVM-only node their combine the various node's node-local storage devices (or multiple storage devices situated on each node) to be accessed via a common address space. The CVM-only node is characterized as CVM-only in the sense that such a CVM-only node comprises a virtualization storage controller that is configured to operate in absence of a hypervisor.

Any of the foregoing methods or configurations of Table 2 or Table 3 can be applied singularly or in combination. Furthermore, a computer program can implement the foregoing methods singularly or in combination.

### Responding to Dynamically-Changing Conditions

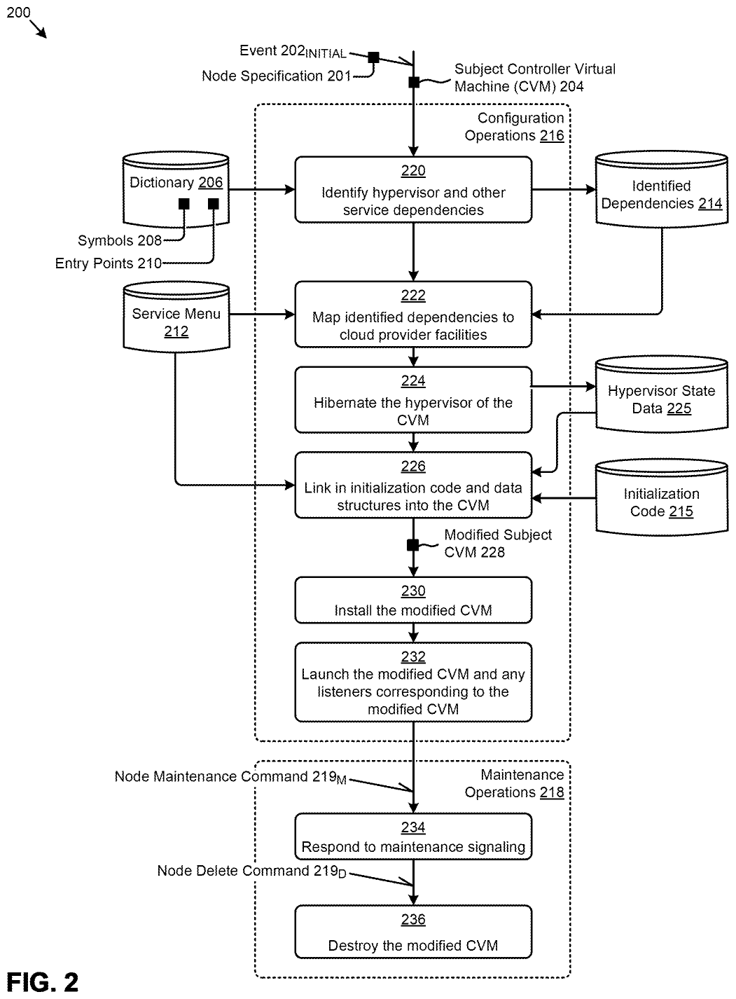

To respond to dynamically-changing conditions, a computer program can be configured so as to implement the foregoing deployment (e.g., expansion or contraction) methods at the right time. One possible embodiment of a computer program that can respond to dynamically-changing computing cluster conditions is shown and described as pertains to FIG. 2.

FIG. 2 depicts a deployment configuration technique that exemplifies an approach for dynamically configuring a hypervisor-less node into a hyperconverged infrastructure computing cluster. As an option, one or more variations of deployment configuration technique 200 or any aspect thereof may be implemented in the context of the architecture and functionality of the embodiments described herein and/or in any environment.

The figure is being presented to explain how a hypervisor-less node can be configured (e.g., as exemplified by the configuration operations 216) and managed over time (e.g., using maintenance operations 218).

Various combinations of the configuration operations and/or maintenance operations can be combined to exploit any one or more desired computing cluster capabilities. Strictly as examples, a sample set of desired computing cluster capabilities that are enabled by the techniques disclosed herein are given in Table 4.

TABLE 4
Table of Desired Computing cluster Characteristics

| Desired Characteristics | How the Desired Characteristics are Achieved |
|---|---|
| Lower the | Start with a smaller initial computing |
| overall cost of | cluster size. One or more nodes can be |
| running workloads | hypervisor-less, yet the CVM still |
| | participates in computing cluster operations |
| | such as storage management and |
| | reaching a computing cluster-wide |
| | quorum/consensus. |
| Improve computing | When deploying a CVM-only node to |
| cluster capacity | handle storage-only traffic, the CPUs need |
| utilization | not be hugely sized. This leads to sizing |
| | optimization in three scaling dimensions. |
| Reduce licensing | When deploying a CVM-only node to |
| costs | handle only certain computing cluster |
| | operations (e.g., storage only access |
| | or consensus resolution), a hypervisor is |
| | not needed; thus the cost of licensing |
| | the hypervisor is eliminated for such a |
| | node. |

The deployment configuration technique 200 of FIG. 2 covers configuration of a computing cluster as well as ongoing maintenance of that computing cluster. More specifically, and as shown, a series of configuration operations 216 are invoked upon occurrence of event 202 INITIAL. As shown, such an event may include or be associated with a node specification 201. The node specification in turn has sufficient information that the operational flow of configuration operations 216 can be carried out to its logical end. In some embodiments, a virtualization storage controller (e.g., subject controller virtual machine 204) is provided. Such a virtualization storage controller is sometimes based on the code base of a fully or partially-configured CVM. Further configuration of the subject controller virtual machine is provided by the flow of configuration operations 216.

To explain in the context of this example embodiment, when reconfiguring a running node to become a CVM-only node, certain of the capabilities provided by the running hypervisor and/or other running services might need to be provided by a node-specific configuration of the subject controller virtual machine. This can be accomplished by considering (1) the specific hypervisor in use and how it is configured, and (2) what hypervisor-provided services or agents need to be accounted for. This can be done by accessing a dictionary 206 that includes symbols 208 and corresponding entry points 210. Using this technique, operation 220 can discover code and/or service dependencies and save the discovered dependencies into a storage area (e.g., such as is exemplified by the shown identified dependencies 214). The discovered dependencies can in turn be used as an input to an operation or operations that map (e.g., operation 222) the discovered dependencies to corresponding alternative implementations (e.g., as depicted by service menu 212). These alternative implementations refer to code or data or application programming interfaces (APIs) that can be brought into or interfaced with the subject controller virtual machine. As such, a particular instance of a subject controller virtual machine can be configured in a manner that eliminates the need for a hypervisor on that node. To completely eliminate the hypervisor from the node however, may require further processing.

This particular example flow includes the operation of hibernating the hypervisor (operation 224), which at least temporarily causes processes that depend on the hypervisor to be at least temporarily quiesced. The act of hibernating the hypervisor might include capturing hypervisor state information (e.g., into hypervisor state data 225), which hypervisor state information can be used when modifying the subject CVM (e.g., at step 226) to bring in or interface with the foregoing alternative implementations of capabilities that were formerly part of or associated with the now hibernated hypervisor. In some cases, modifying the subject CVM includes bringing in or interfacing with initialization code 215. Such initialization code can be provided by the maker/vendor of the CVM, or it can be provided by a cloud vendor, or both. In some implementations, the initialization code serves to reproduce the state of the hypervisor at the time it was hibernated. In one particular configuration, the initialization code allows the CVM itself to reproduce the state of the hypervisor at the time it was hibernated. In another particular configuration, a first portion of initialization code corresponds to accessing and/or initializing cloud provider facilities, whereas a second portion of initialization code corresponds to accessing and/or initializing interfaces or agents of an on-premises computing cluster.

Now, having a modified subject CVM 228, in a manner that can reproduce the state of the node just prior to when the node's hypervisor was hibernated, the flow can proceed (e.g., to step 230) where the modified CVM and any listeners corresponding to the modified CVM is installed on the node (e.g., at step 230). Then, once the modified CVM and any of its listeners have been launched (step 232), the node can be restored to its state just prior to hibernation of the hypervisor-yet the hypervisor is not needed. The unneeded hypervisor license can be returned to a license pool and billing for usage of the hibernated instance of the hypervisor can cease. Furthermore, in the case of CVM-only nodes, licenses to other components beyond the hypervisor are not needed. For example, a bundled bare metal configuration might include licenses to various licensed products, however a CVM-only node does not need to allocate such licensed product licenses.

Further details regarding general approaches to hibernating hypervisors are described in U.S. Pat. No. 11,593,137 titled “HYPERVISOR HIBERNATION” issued on Feb. 28, 2023, which is hereby incorporated by reference in its entirety.

A computer program that implements a method of forming a controller virtualized machine node from a hyperconverged infrastructure (HCI) node, can include the steps of: (1) identifying dependencies of the HCI node on hypervisor functions and other service dependencies (2) mapping the identified hypervisor functions and other service dependencies to one or more of, (a) cloud provider facilities and/or (b) initialization code for the cloud provider facilities; and (3) creating (e.g., based at least in part on the mapping), a modified hyperconverged infrastructure (HCI) node. Then, prior to initiating execution of the modified hyperconverged infrastructure (HCI) node, relinquishing or destroying or hibernating the hypervisor of the hyperconverged infrastructure (HCI) node.

Configuration into a Storage-Only Node

The reconfigured, hypervisor-less, CVM-only node can serve as a node of the computing cluster. More specifically, since the CVM is able to process storage-related communications and/or redirect such storage-related communications to another CVM in the computing cluster, that node can serve as a storage-only node. Of course, there may be many reasons why the node needs maintenance (e.g., to undergo further configuration or reconfiguration), and/or to be removed from the computing cluster (possibly in favor of a replacement node). Accordingly, maintenance operations 218 are provided. As shown, maintenance operations 218 can respond to a node maintenance command 219M or to a node delete command 219D. Specifically, a listener (e.g., a first listener corresponding to the modified CVM) can recognize the occurrence of a node maintenance command 219M and invoke operations to respond to maintenance signaling (step 234). Similarly, a listener (e.g., a second listener corresponding to the modified CVM) can recognize the occurrence of a node delete command 219D and invoke operations to respond to the command (step 236).

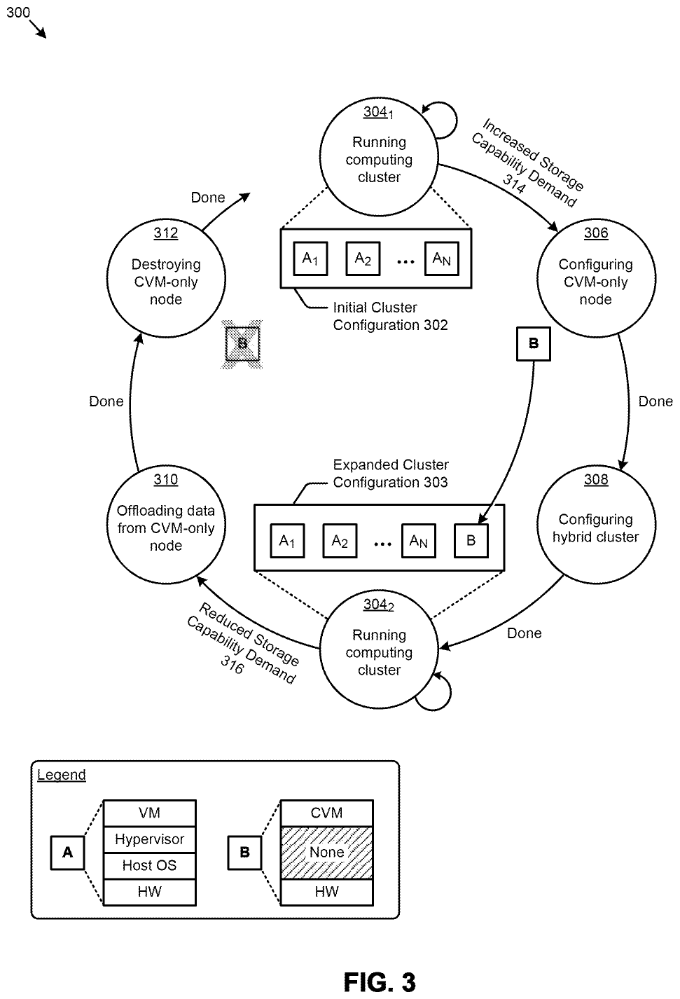

In a manner such as is heretofore discussed, an arbitrary computing cluster node having a hypervisor can be reconfigured to be a hypervisor-less node of the computing cluster. Such an arbitrary computing cluster node having a hypervisor can be drawn from available on-premises computing nodes and reconfigured to be a hypervisor-less node of the on-premises computing cluster. Alternatively, a computing cluster node can be drawn from available cloud-provided computing nodes and reconfigured to be a hypervisor-less node of a hybrid computing cluster (e.g., a computing cluster formed partially from on-premises computing infrastructure and partially from cloud-provided computing infrastructure). A computing cluster expansion and contraction involving the full cradle-to-grave lifecycle of a hypervisor-less node of a hybrid computing cluster is shown and described as pertains to FIG. 3.

FIG. 3 shows a state chart to illustrate one possible HCI computing cluster expansion and contraction technique as used in systems that integrate dynamically-configured hypervisor-less nodes into hyperconverged infrastructure computing clusters. As an option, one or more variations of HCI computing cluster expansion and contraction technique 300 or any aspect thereof may be implemented in the context of the architecture and functionality of the embodiments described herein and/or in any environment.

The figure is being presented to illustrate how a cloud-provided node drawn from a pool of cloud-provided nodes (shown as node ‘B’) can be added to a computing cluster as a storage-only node, used for a time in this configuration, then returned to the pool of cloud-provided nodes.

The shown lifecycle starts at state 304₁, where there is a running computing cluster in some initial computing cluster configuration 302. At some moment in time, one or more listeners of the computing cluster recognize that there is increased storage capability demand 314. The system now might determine that the most efficient way to deal with the specified increased storage capability demands is to expand the computing cluster to include a specially-configured storage-only node. Accordingly, the system might move to state 306, wherein operations for configuring a CVM-only node are carried out. Once the operations for configuring the CVM-only node have been carried out, the node is in a condition to be configured into the computing cluster to form an expanded computing cluster. Accordingly, the system enters state 308, wherein operations for bringing the CVM-only node into operation as a node of the computing cluster are carried out. This then forms an expanded computing cluster configuration 303 such as is shown as corresponding to state 304₂, wherein the expanded computing cluster configuration 303 runs workloads. The computing portion of workloads execute on computing node A₁ through node A_{N}, whereas at least some of the storage communication is handled by node B. This configuration can run continuously, at least until such time as one or more listeners of the computing cluster recognize that there is a decreased storage capability demand 316.

The system now might determine that the most efficient way to deal with the decreased storage demand is to contract the computing cluster to eliminate the formerly-added specially-configured storage-only node ‘B’. Accordingly, the system might move to state 310, wherein any data that was stored on the specially-configured storage-only node ‘B’ can be moved to other nodes of the computing cluster, and then quiesced in advance of being destroyed (state 312). More specifically, when fully quiesced, the specially-configured storage-only node ‘B’ can be wiped clean of data and re-initialized with a new image of a host operating system. Before being wiped clean and re-initialized, the formerly-added, specially-configured storage-only node ‘B’ undergoes processing whereby any resources that had been allocated by or on behalf of node ‘B’ can be returned to the pool from which the resources had been allocated. In some cases, returning resources to the pool from which they had been allocated has a corresponding billing effect. For example, returning cloud-provided storage resources to the cloud-provided pool of storage would have the billing effect of ceasing billing monitoring over those storage resources. In some cases, billing for storage resources includes billings based on IOPS. In such cases, once the specially-configured storage-only node ‘B’ has been quiesced, then billing is quiesced commensurately.

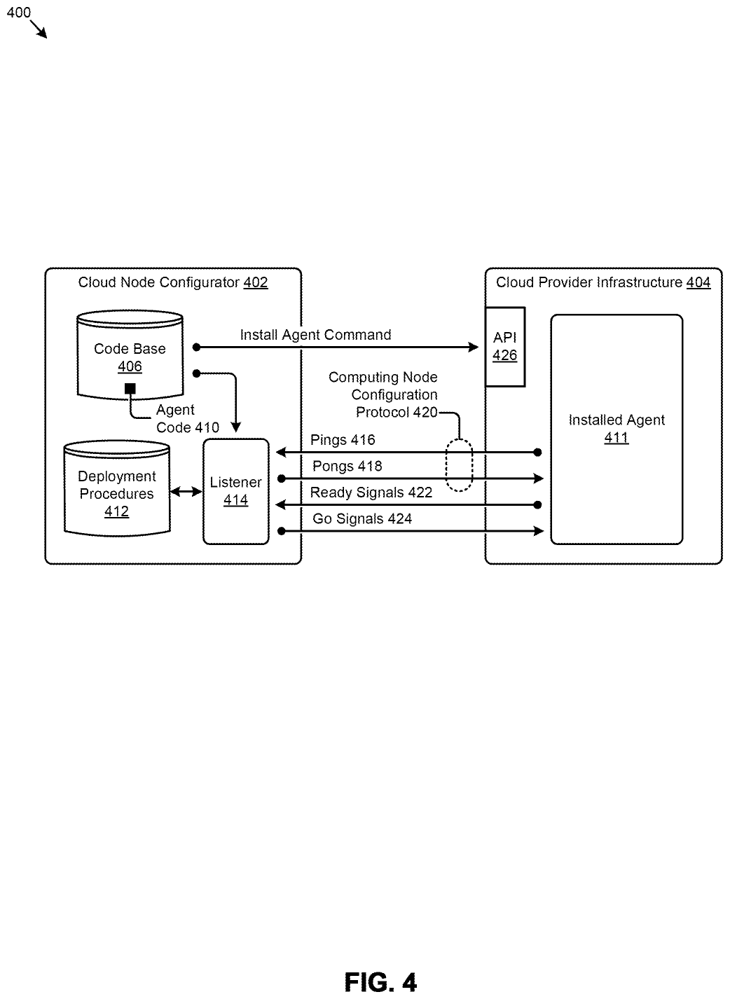

In many cloud settings where a cloud vendor provides infrastructure that is offered out for use by the public (e.g., on demand or by subscription, etc.), it often happens that the cloud infrastructure is hardened against malicious accesses. In some such settings, network communication streams between on-premises infrastructure and the cloud provider's infrastructure can only be initiated from within a cloud-provided node. Accordingly, it might be felicitous to define an agent that can initiate network communication streams between on-premises infrastructure and the cloud provider's infrastructure. In some cases, such an agent can initiate network communication streams between on-premises infrastructure and the cloud provider's infrastructure for the specific purpose of configuring a hypervisor-less node using cloud-based hyperconverged infrastructure. One possible deployment of an agent that assists in dynamically configuring hypervisor-less nodes onto cloud-based infrastructure is shown and described as pertains to FIG. 4.

FIG. 4 depicts a system that implements a deployment configuration technique for dynamically configuring hypervisor-less nodes into a cloud-based hyperconverged infrastructure computing cluster. As an option, one or more variations of deployment configuration technique 400 or any aspect thereof may be implemented in the context of the architecture and functionality of the embodiments described herein and/or in any environment.

The figure is being presented to illustrate how cloud-provided infrastructure can be used to expand a computing cluster-even when the cloud infrastructure is hardened against malicious accesses. In this illustration, an agent is deployed into the cloud-provided infrastructure via API 426. After network communications have been established, and once the agent has been accepted into the cloud-provided infrastructure, the agent can initiate and carry out network communication between on-premises infrastructure and the cloud provider's infrastructure. Strictly as an example, network communications between the cloud provider infrastructure 404 and a cloud node configurator 402 can be in the form of a sequence of pings 416, and pongs 418 (e.g., to carry out a computing node configuration protocol 420), plus one or more ready signals 422 and one or more go signals 424.

Further details regarding approaches to using a sequence of pings and pongs are described in U.S. Patent Application Publication No. 2023/0036454 titled “COMPUTING CLUSTER BRING-UP ON PUBLIC CLOUD INFRASTRUCTURE USING EXPRESSED INTENTS” published on Feb. 2, 2023, which is hereby incorporated by reference in its entirety.

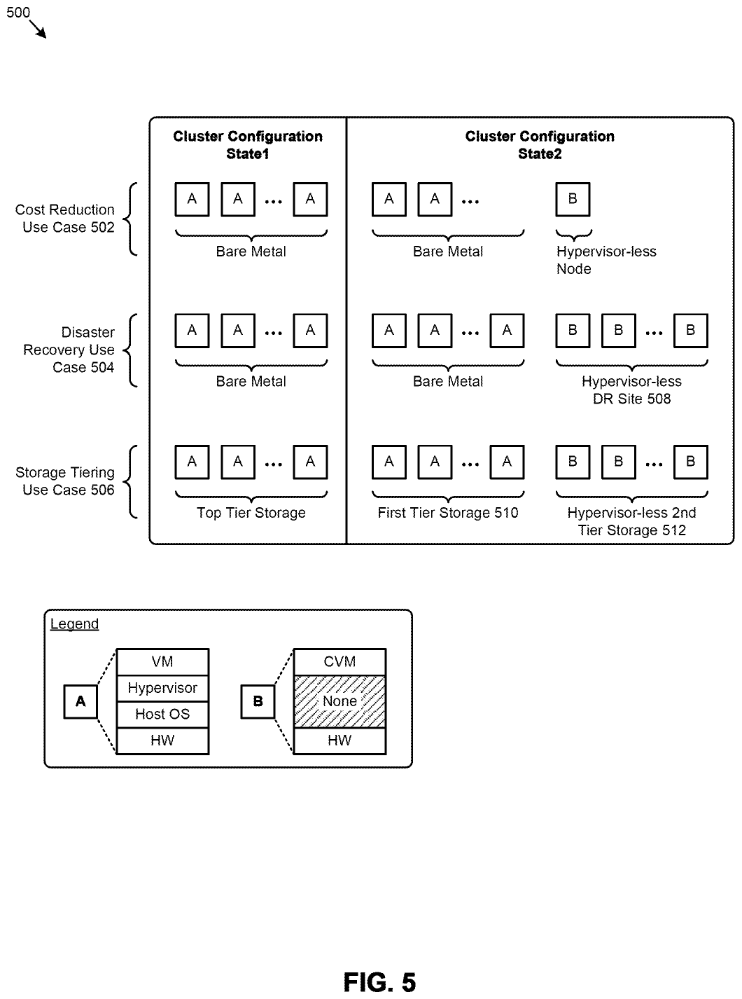

As shown, the hybrid cloud configurator module comprises or accesses a code base 406, which code base includes executable code for an agent (e.g., agent code 410). Further the cloud node configurator 402 comprises or accesses deployment procedures 412, which in turn accesses listener 414. Listener 414 is configured to receive network communications as raised from within the cloud provider infrastructure (e.g., pings 416) and respond with pongs 418. In many cases, pongs (e.g., communications back to installed agent 411 comprise executable code drawn from code base 406). In this manner any type of executable code can be deployed onto the cloud infrastructure, including code needed to implement a CVM-only node. Further, certain types of executable code can be deployed onto the cloud infrastructure so as to configure all or portions of a computing cluster on cloud-provided infrastructure. Still further, different types of executable code can be deployed onto the cloud infrastructure so as to dynamically configure and reconfigure all or portions of a computing cluster on cloud-provided infrastructure so as to achieve one or more configurations corresponding to specific use cases. In fact, a computing cluster can be repeatedly reconfigured into different configuration states that comport with the computing, networking, and storage demands of any particular use case. Various possible configuration states and transitions to other configuration states are shown and discussed as pertains to FIG. 5.

FIG. 5 illustrates a series of computing cluster configuration state transitions that occur in systems that dynamically configure hypervisor-agnostic nodes using public cloud computing infrastructure. As an option, one or more variations of computing cluster configuration state transitions 500 or any aspect thereof may be implemented in the context of the architecture and functionality of the embodiments described herein and/or in any environment.

The figure is being presented to illustrate how a computing cluster configuration can change by implementing one or more instances of CVM-only nodes (e.g., shown as nodes of node type ‘B’). Three uses cases are presented: First, a cost reduction use case 502; second, a disaster recovery use case 504; and third, a storage tiering use case 506. The paragraphs below explain how one or more instances of CVM-only nodes can be deployed to comport with the requirement of each particular use case.

As shown, the cost reduction use case 502 begins in computing cluster configuration state1 having a plurality of instances of bare metal node instances, shown as three or more instances of bare metal node ‘A’. To achieve the desired cost reduction aspect, one of the three or more instances of bare metal node ‘A’ are returned to the bare metal pool. The particular one of the three or more instances of bare metal node ‘A’ that are returned to the bare metal pool is replaced by a hypervisor-less node ‘B’ that is less costly than the node it replaces. Depending on the configuration, a hypervisor-less node is less costly than the bare metal node that it replaces at least because bare metal nodes that are configured to host user VMs tend to be extremely capable (e.g., with many high clock rate CPUs, very large amounts of memory, etc.) and commensurately costly, whereas a bare metal node that is configured as a CVM-only node (hypervisor-less) need not be so capably configured. Accordingly, and as shown by computing cluster configuration state2, the computing functions of a third node (e.g., computing functions for reaching a consensus) are configured onto an instance of the shown hypervisor-less node, node ‘B’. This is potentially a much lower cost configuration of the computing cluster while still offering the advantages of a computing cluster. The shown disaster recovery use case 502 begins in computing cluster configuration state1 having a plurality of instances of bare metal node instances, shown as three or more instances of bare metal node ‘A’. To achieve the desired cost reduction aspect, while still taking advantage of lower operating costs, a plurality of instances of hypervisor-less nodes (e.g., three or more instances, as shown) any or all of which are less costly than the bare metal nodes of configuration ‘A’, are configured as a disaster recovery (DR) site (e.g., hypervisor-less DR site 508, as shown). This results in a potentially much lower cost configuration of the recoverable computing cluster while still offering the advantages of a distally-situated disaster recovery site.

Also shown in FIG. 5 is a storage tiering use case 506. Here, a second tier of storage (e.g., slower, less costly storage) can be implemented by a plurality of instances of hypervisor-less nodes (e.g., three or more instances, as shown) any or all of which are less costly than the bare metal nodes of configuration ‘A’. As such, a second tier of storage (e.g., hypervisor-less 2^{nd} tier storage 512, as shown) can be implemented at an ongoing, significantly lower operating cost point as compared with adding bare metal nodes to implement the second tier of storage. As shown, the hypervisor-less 2^{nd} tier storage 512, is implemented a second tier storage 512 that is subordinate to top tier storage 510.

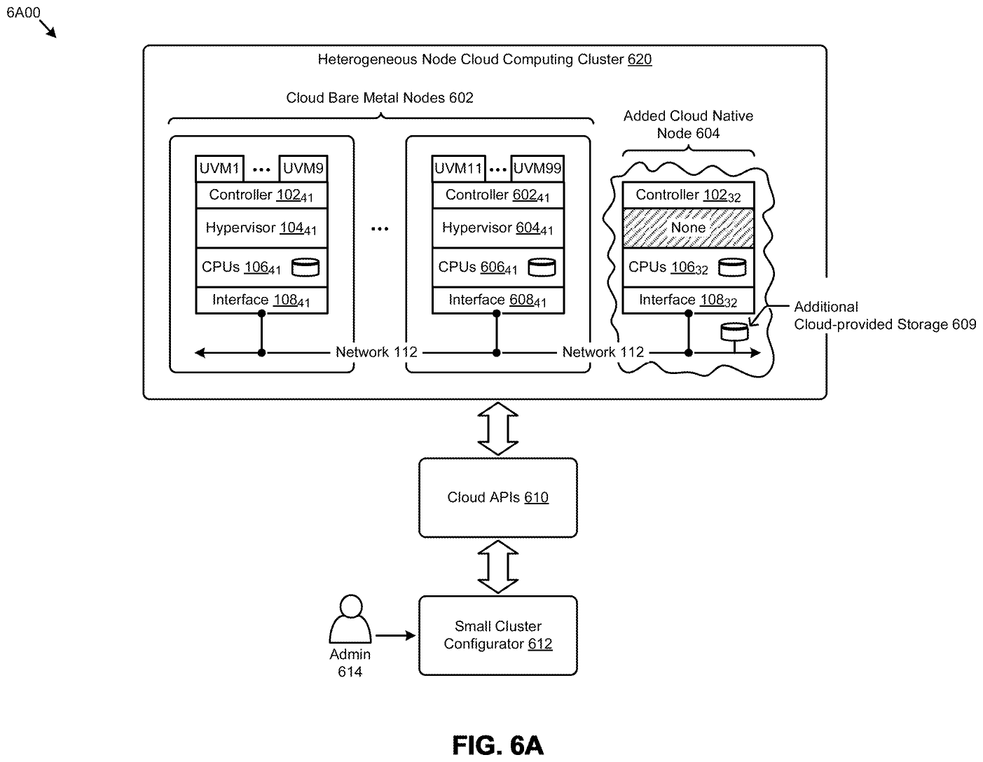

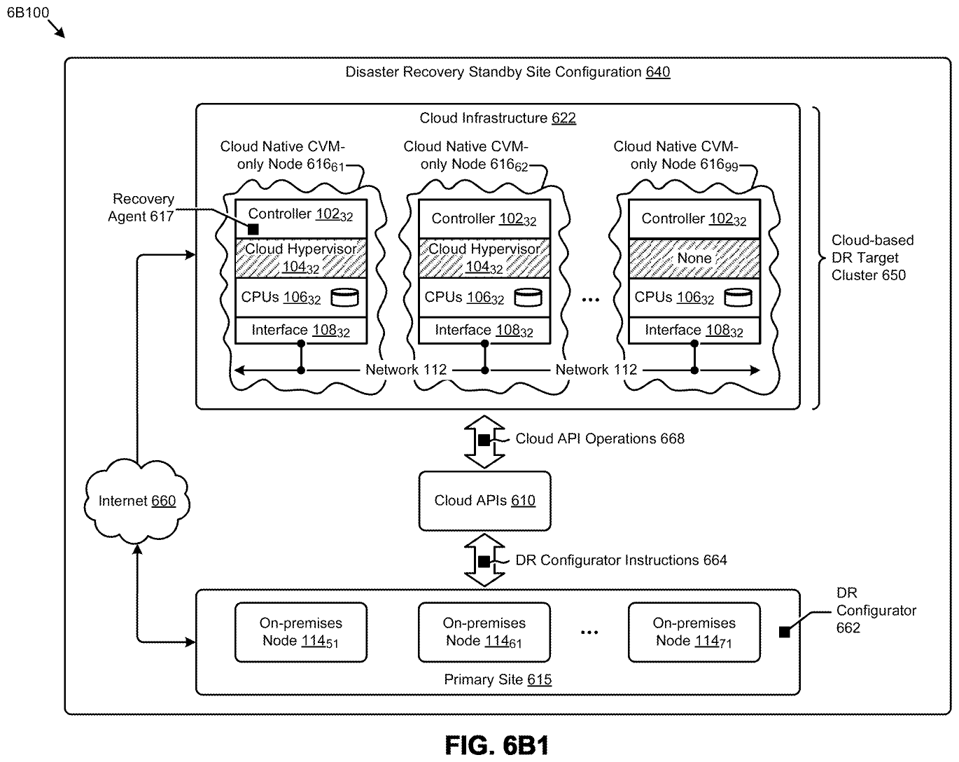

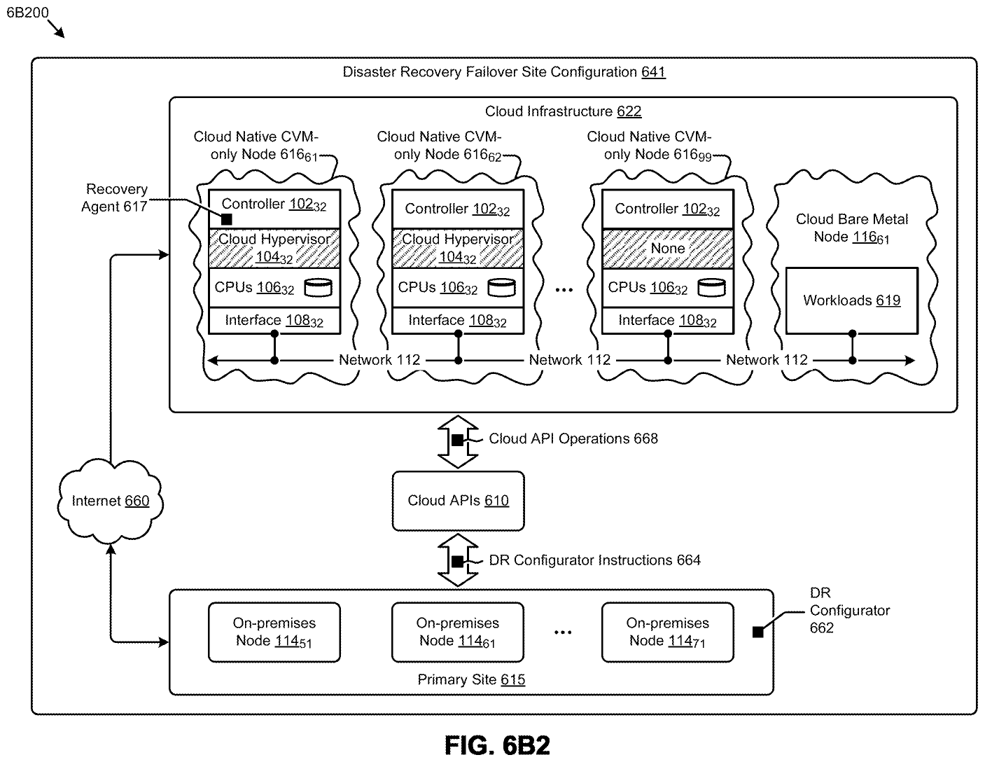

FIG. 6A illustrates a small computing cluster configuration technique as used in systems that dynamically configure hypervisor-agnostic nodes into an HCI computing cluster using public cloud computing infrastructure. As an option, one or more variations of small computing cluster configuration technique 6A00 or any aspect thereof may be implemented in the context of the architecture and functionality of the embodiments described herein and/or in any environment.

The figure is being presented to illustrate how a three-node computing cluster can be formed using two bare metal nodes and one low-cost CVM-only node. Such a configuration is needed at least inasmuch as, for many cluster configurations, a minimum of three nodes are required (e.g., for handling majority voting over atomic operations). However, in some cases, the minimum three-node configuration (e.g., three bare metal nodes) offers far more computing, storage and networking capabilities than is needed by the customer's workloads. Unfortunately, this situation can incur heavy costs to deploy the three nodes. A better way is sought. One situation admits of the possibility is to deploy a hybrid node cluster (e.g., heterogeneous node cluster) with just two bare metal nodes and one CVM-only node that is configured onto a cloud-native node within the cloud infrastructure. This is desirable in this situation since the overhead of maintaining a CVM-only node is much less than maintaining an bare metal node.

In spite of the fact that a cloud-native node within the cloud infrastructure incurs much less overhead than bare metal nodes, deployment of a CVM-only cloud-native node offers expansion flexibility. If, for example, the customer is running into storage constraints, the customer can merely allocate additional cloud-provided storage 609. Or if, for example, the customer is running into workload computing constraints, the customer can merely allocate an additional virtual machine that runs on flexibly-allocatable cloud-provided infrastructure.

To further explain, and as can be seen by inspection of FIG. 6A, a heterogeneous node cloud computing cluster 620 is formed by configuring a CVM-only node that operates in conjunction with ordinary HCI nodes. As shown, two nodes of the three-node heterogeneous node cloud computing cluster are hosted on cloud bare metal nodes 602, whereas the third (or Nth) node is hosted on an added cloud native node 604. Each of the cloud bare metal nodes 602 has its own CPUs (e.g., CPU 106₄₁ and CPU 606₄₁), its own network interface (e.g., interface 108₄₁ and 608₄₁), and its own virtualization storage controller (e.g., controller 102₄₁ and controller 602₄₁). Furthermore, the cloud bare metal nodes 602 are configured to run workloads on various user virtual machines (e.g., UVM1, . . . , UVM9 and UVM11, . . . , UVM99).

Certain non-workload computing tasks can be handled by the third node of the heterogeneous node cloud computing cluster. As one use case example, the third node of the heterogeneous node cloud computing cluster can carry out a protocol to form a majority (e.g., with one of the cloud bare metal nodes) when cluster-wide atomic operations are being considered. This is facilitated in that the added cloud native node 604 has its own CVM (e.g., controller 102₃₂) and its own CPUs 106₃₂) that can serve, for example, as a quorum member or, for example, as a witness in atomic operations. As yet another use case example, the third node of the heterogeneous node cloud computing cluster can be used to add storage capacity. This is shown in that the added cloud native node 604 has its own network interface (e.g., interface 108₃₂) that is capable of accessing network-attached storage (e.g., additional cloud-provided storage 609). Network-attached storage can be made accessible to any node on network 112.

A configuration such as the foregoing can be brought up automatically (e.g., configured autonomously based on functionality of the CVM), or by an administrator (e.g., admin 614) who accesses small cluster configurator 612, which in turn accesses cloud APIs 610 to initialize and monitor the heterogeneous node cloud computing cluster configuration 620.

The foregoing are merely illustrative examples. Other examples abound, including deployment of one or more CVM-only nodes into a disaster recovery standby site 640. One implementation of such a disaster recovery standby site is shown and described as pertains to FIG. 6B1.

FIG. 6B1 illustrates a disaster recovery standby site configuration technique as used in systems that dynamically configure hypervisor-agnostic nodes into an HCI computing cluster using public cloud computing infrastructure. As an option, one or more variations of disaster recovery standby site configuration technique 6B100 or any aspect thereof may be implemented in the context of the architecture and functionality of the embodiments described herein and/or in any environment.

For certain disaster recovery use cases, a cloud-based DR target cluster 650 can be configured onto cloud infrastructure 622 by deploying one or more dynamically allocated cloud native CVM-only nodes (e.g., cloud native CVM-only node 616₆₁, cloud native CVM-only node 616₆₂, . . . , cloud native CVM-only node 616₉₉) and interconnecting them to form a computing cluster. Such deployment and interconnection can be facilitated by a DR configurator 662. A DR configurator can form DR configurator instructions 664 which are used to operate cloud APIs 610, which in turn cause cloud API operations 668 to be carried out over the cloud infrastructure. A DR configurator can execute on any node of the primary site (e.g., on-premises node 114₅₁, on-premises node 114₆₁, or on-premises node 114₇₁). Additionally or alternatively, a node other than any node of the primary site can be employed to perform some or all of the functions of the DR configurator.

In certain embodiments, at least one of the dynamically allocated cloud native CVM-only nodes includes a recovery agent 617. A recovery agent can detect autonomously, or be advised of a disaster event and/or a failover event (e.g., based on communications over the Internet 660), upon which event or events the recovery agent can initiate steps necessary to reconfigure the cloud-based DR target cluster such that the cloud-based DR target cluster has sufficient computing resources to serve as a failover cluster.

Specifically, in case of disaster event and the need to failover to the disaster recovery site, any number of bare metal instances can be added to the cloud-based DR target cluster 650. Such bare metal instances can be sized appropriately to be able to perform failover operations as well as recovery tasks, including performing workloads that were formerly running on the primary site 615. FIG. 6B2 illustrates one possible technique where a dynamically-instanced bare metal node extends the capabilities of disaster recovery failover site configuration 641 so as to be able to perform failover operations as well as any sorts of recovery operations including failback.

FIG. 6B2 illustrates a disaster recovery failover site configuration technique. As an option, one or more variations of disaster recovery failover site configuration technique 6B200 or any aspect thereof may be implemented in the context of the architecture and functionality of the embodiments described herein and/or in any environment.

As shown, a cloud bare metal node 116₆₁ is added to form disaster recovery failover site configuration 641. In this embodiment, the cloud bare metal node 116₆₁ is dynamically allocated from cloud infrastructure 622, which is configured onto network 112 so as to be able to run workloads 619 which in turn access data of the backup cluster storage. In this embodiment, the data of the backup cluster storage had been delivered to the backup cluster (e.g., from a primary cluster) on an ongoing basis during the running of the primary cluster, and that data had been distributed across the cloud native CVM-only nodes. Additionally or alternatively, the added instance of the cloud bare metal node can be configured to access primary site 615 (e.g., over Internet 660) so as to be ready to perform failback operations in the event that the primary site 615 is brought back online after the disaster event.

### Additional Embodiments of the Disclosure

### Feature as a Service (FaaS)

The foregoing figures and the discussed embodiments are merely illustrative. Many further embodiments are possible. Strictly as examples of such further embodiments, a computing cluster formed of all CVM-only nodes has the potential to serve any number of feature-as-a-service (FaaS) use cases. For example, such a computing cluster formed of all CVM-only nodes can implement new file systems as a service, and or can implement custom objects as a service. These types of FaaS use cases do not need to support user VMs. This is because the foregoing FaaS features are built into the CVM.

### Reserved Instance Abatement Use Case

Certain computing cluster configurations require a minimum of three physical failure domain partitions. However, it is not always guaranteed that dynamically-allocated bare metal instances will be in separate failure domains (e.g., separate racks). To account for this lack of guarantee, customers have relied on reserved instances (RI) for which they have to pay RI costs upfront. As an alternative, customers can dynamically allocate (e.g., in lieu of paying upfront costs for RIs) any number of non-bare metal instances that are readily available (e.g., in all regions and availability zones) to be drawn from.

### A New Hypervisor Type

Many virtualization system services depend on the underlying hypervisor type or, more specifically, many virtualization system services depend on availability of features or services of the underlying hypervisor. Inasmuch as at least some of the foregoing computing cluster embodiments involving one or more CVM-only nodes that do not have hypervisors at all, there are some situations where it is convenient to implement features or services at the computing stack layer where a hypervisor would normally be situated.

### Implementing a Never Schedulable Configuration Setting

A Never Schedulable configuration flag is provided. When activated (e.g., when set to TRUE), this flag ensures that user virtual machines are not scheduled on a corresponding CVM-only node.

### Ongoing Maintenance

In order to decide whether a given node is a CVM-only node, a node attribute and value (e.g., CVM_ONLY=TRUE) can be defined. This attribute serves as a single source of truth for its corresponding node. Moreover this attribute can be used by maintenance tasks that need to handle CVM-only nodes differently than ordinary HCI nodes.

### System Architecture Overview

### Additional System Architecture Examples

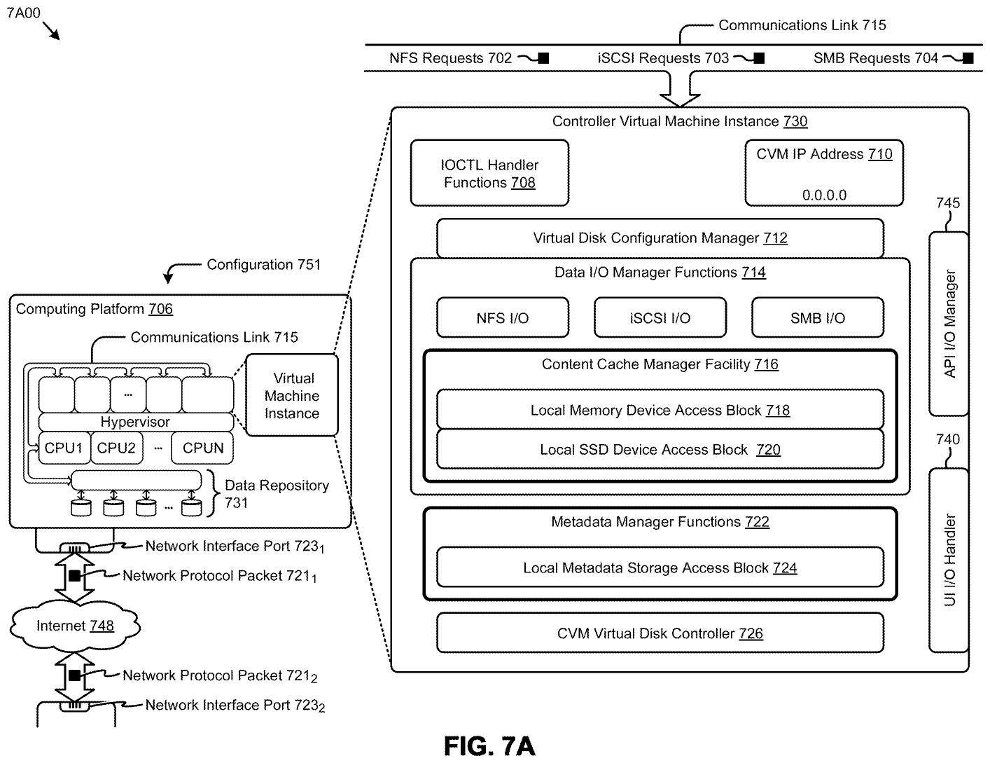

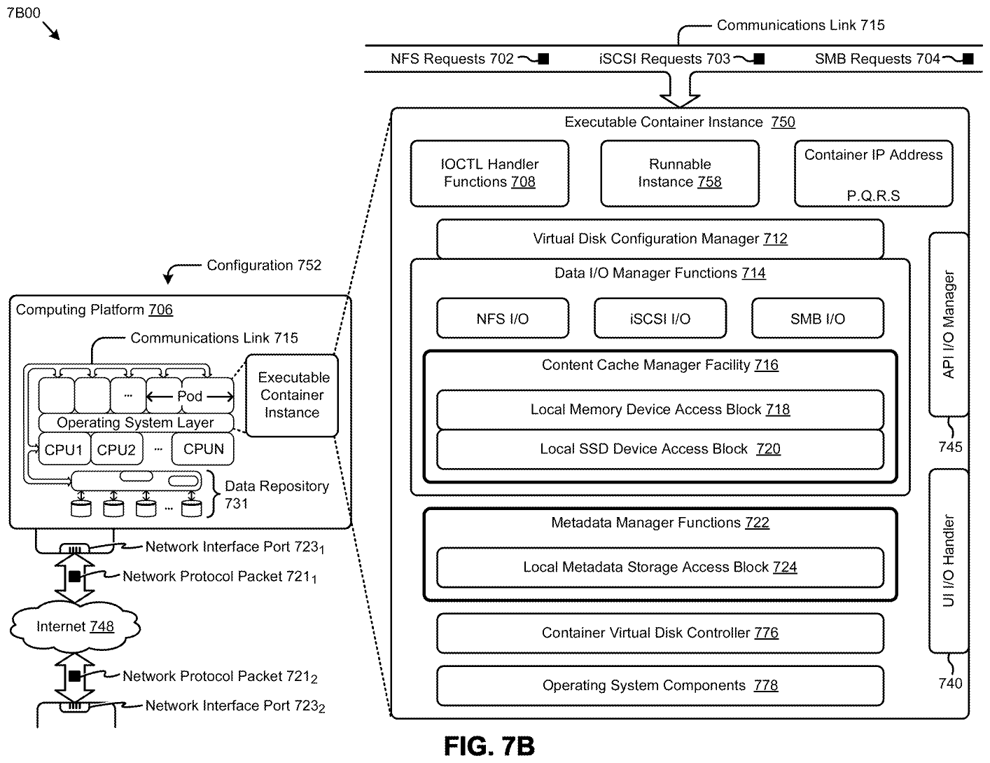

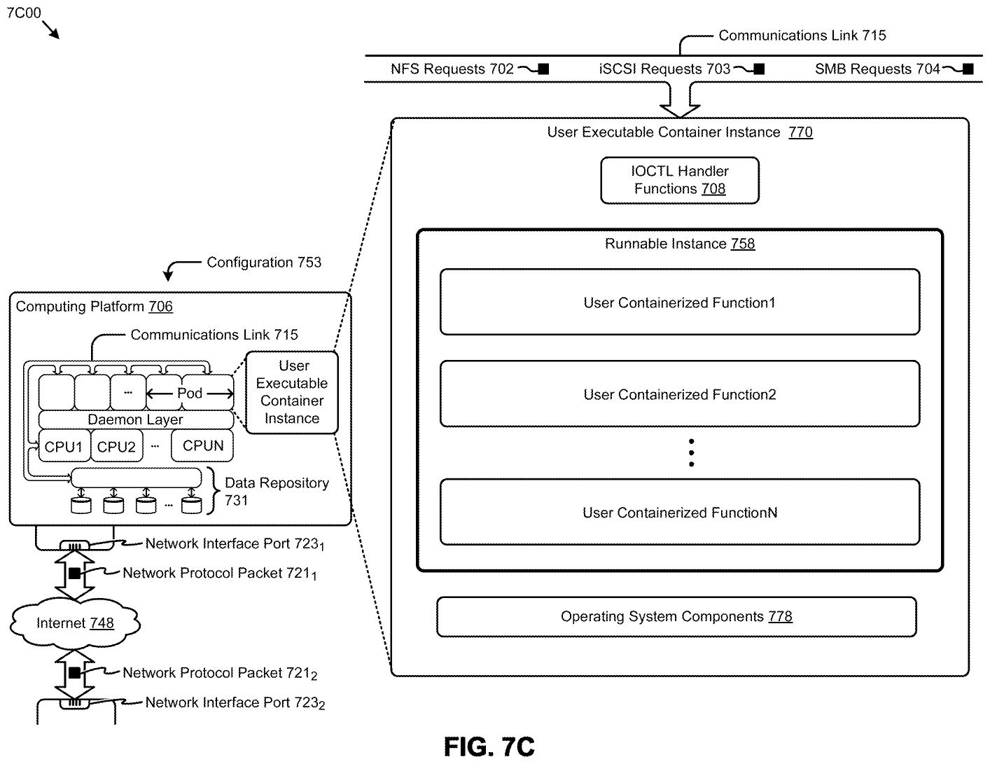

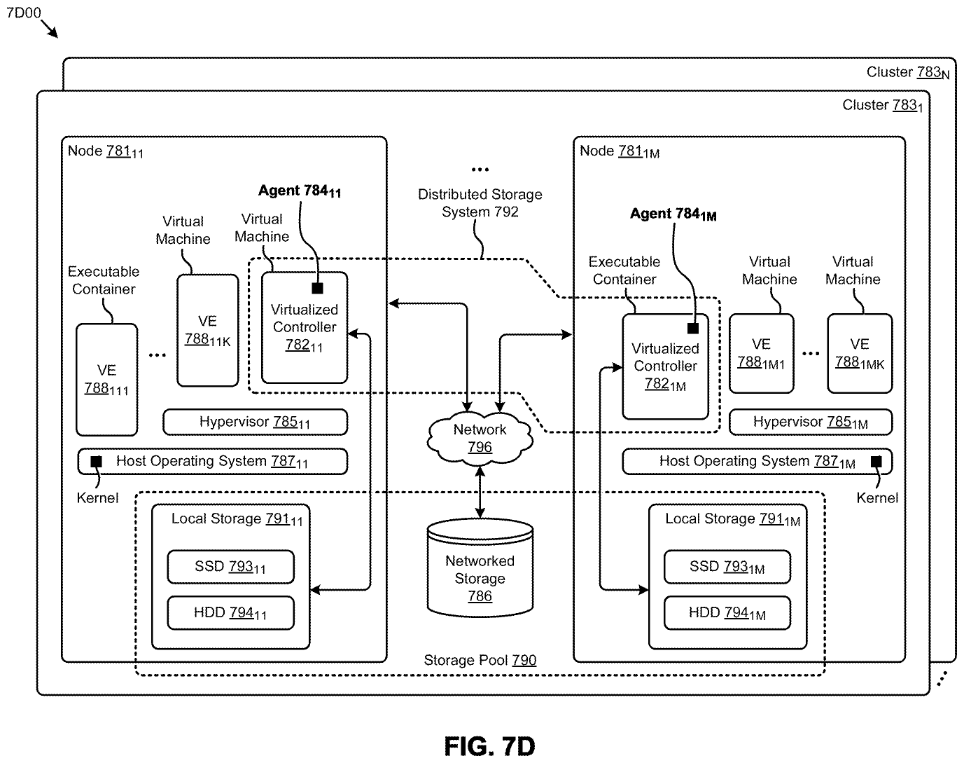

All or portions of any of the foregoing techniques can be partitioned into one or more modules and instanced within, or as, or in conjunction with, a virtualized controller in a virtual computing environment. More particularly, various embodiments of the foregoing virtualization storage controllers can be implemented in whole or in part by a virtualized controller such as is described in detail hereunder. Some example instances of virtualized controllers situated within various virtual computing environments are shown and discussed as pertains to FIG. 7A, FIG. 7B, FIG. 7C, and FIG. 7D.

FIG. 7A depicts a virtualized controller as implemented in the shown virtual machine architecture 7A00. The heretofore-disclosed embodiments, including variations of any virtualized controllers (e.g., virtualization storage controllers), can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as a layer in a hypervisor). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 7A00 comprises a collection of interconnected components suitable for implementing embodiments of the present disclosure and/or for use in the herein-described environments. Moreover, virtual machine architecture 7A00 includes a virtual machine instance in configuration 751 that is further described as pertaining to controller virtual machine instance 730. Configuration 751 supports virtual machine instances that are deployed as user virtual machines, or controller virtual machines or both. Such virtual machines interface with a hypervisor (as shown). Some virtual machines are configured for processing of storage inputs or outputs (I/O or IO) as received from any or every source within the computing platform. An example implementation of such a virtual machine that processes storage I/O is depicted as 730.

In this and other configurations, a controller virtual machine instance receives block I/O storage requests as network file system (NFS) requests in the form of NFS requests 702, and/or internet small computer system interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., CVM IP address 710). Various forms of input and output can be handled by one or more IO control (IOCTL) handler functions (e.g., IOCTL handler functions 708) that interface to other functions such as data IO manager functions 714 and/or metadata manager functions 722. As shown, the data IO manager functions can include communication with virtual disk configuration manager 712 and/or can include direct or indirect communication with any of various block IO functions (e.g., NFS IO, iSCSI IO, SMB IO, etc.).

In addition to block IO functions, configuration 751 supports input or output (IO) of any form (e.g., block IO, streaming IO) and/or packet-based IO such as hypertext transport protocol (HTTP) traffic, etc., through either or both of a user interface (UI) handler such as UI IO handler 740 and/or through any of a range of application programming interfaces (APIs), possibly through API IO manager 745.

Communications link 715 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 730 includes content cache manager facility 716 that accesses storage locations, possibly including local dynamic random access memory (DRAM) (e.g., through local memory device access block 718) and/or possibly including accesses to local solid state storage (e.g., through local SSD device access block 720).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 731, which in turn can be formatted into any one or more storage areas, and which can comprise parameterized storage accessible by a key (e.g., a filename, a table name, a block address, an offset address, etc.). Data repository 731 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 724. The data repository 731 can be configured using CVM virtual disk controller 726, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 751 can be coupled by communications link 715 (e.g., backplane, local area network, public switched telephone network, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 723₁ and network interface port 723₂). Configuration 751 can be addressed through one or more network interface ports using an IP address. Any operational element within computing platform 706 can perform sending and receiving operations using any of a range of network protocols, possibly including network protocols that send and receive packets (e.g., network protocol packet 721₁ and network protocol packet 721₂).

Computing platform 706 may transmit and receive messages that can be composed of configuration data and/or any other forms of data and/or instructions organized into a data structure (e.g., communications packets). In some cases, the data structure includes program instructions (e.g., application code) communicated through the Internet 748 and/or through any one or more instances of communications link 715. Received program instructions may be processed and/or executed by a CPU as it is received and/or program instructions may be stored in any volatile or non-volatile storage for later execution. Program instructions can be transmitted via an upload (e.g., an upload from an access device over the Internet 748 to computing platform 706). Further, program instructions and/or the results of executing program instructions can be delivered to a particular user via a download (e.g., a download from computing platform 706 over the Internet 748 to an access device).

Configuration 751 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A computing cluster is often embodied as a collection of computing nodes that can communicate between each other through a local area network (LAN) and/or through a virtual LAN (VLAN) and/or over a backplane. Some computing clusters are characterized by assignment of a particular set of the aforementioned computing nodes to access a shared storage facility that is also configured to communicate over the local area network or backplane. In many cases, the physical bounds of a computing cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger computing clusters. For example, the LAN of a first rack having a quantity of 32 computing nodes can be interfaced with the LAN of a second rack having 16 nodes to form a two-rack computing cluster of 48 nodes. The former two LANs can be configured as subnets, or can be configured as one VLAN. Multiple computing clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to dynamically configuring hypervisor-less nodes in hyperconverged infrastructure computing clusters. In some embodiments, a module may include one or more state machines and/or combinational logic used to implement or facilitate the operational and/or performance characteristics of dynamically configuring hypervisor-less nodes in hyperconverged infrastructure computing clusters.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of dynamically configuring hypervisor-less nodes in hyperconverged infrastructure computing clusters). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to dynamically configuring hypervisor-less nodes in hyperconverged infrastructure computing clusters, and/or for improving the way data is manipulated when performing computerized operations pertaining to infrastructure-independent scaling of hyperconverged computing nodes.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 7B depicts a virtualized controller implemented by containerized architecture 7B00. The containerized architecture comprises a collection of interconnected components suitable for implementing embodiments of the present disclosure and/or for use in the herein-described environments. Moreover, the shown containerized architecture 7B00 includes an executable container instance in configuration 752 that is further described as pertaining to executable container instance 750. Configuration 752 includes an operating system layer (as shown) that performs addressing functions such as providing access to external requestors (e.g., user virtual machines or other processes) via an IP address (e.g., “P.Q.R.S,” as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 750). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a corresponding virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls,” “dir,” etc.). The executable container might optionally include operating system components 778, however such a separate set of operating system components need not be provided. As an alternative, an executable container can include runnable instance 758, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 776. Such a container virtual disk controller can perform any of the functions that the aforementioned CVM virtual disk controller 726 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 7C depicts a virtualized controller implemented by a daemon-assisted containerized architecture 7C00. The containerized architecture comprises a collection of interconnected components suitable for implementing embodiments of the present disclosure and/or for use in the herein-described environments. Moreover, the shown daemon-assisted containerized architecture includes a user executable container instance in configuration 753 that is further described as pertaining to user executable container instance 770. Configuration 753 includes a daemon layer (as shown) that performs certain functions of an operating system.

User executable container instance 770 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 758). In some cases, the shown operating system components 778 comprise portions of an operating system, which portions are interfaced with or included in the runnable instance and/or any user containerized functions. In this embodiment of a daemon-assisted containerized architecture, the computing platform 706 might or might not host operating system components other than operating system components 778. More specifically, the shown daemon might or might not host operating system components other than operating system components 778 of user executable container instance 770.

The virtual machine architecture 7A00 of FIG. 7A and/or the containerized architecture 7B00 of FIG. 7B and/or the daemon-assisted containerized architecture 7C00 of FIG. 7C can be used in any combination to implement a distributed platform that contains multiple servers and/or nodes that manage multiple tiers of storage where the tiers of storage might be formed using the shown data repository 731 and/or any forms of network accessible storage. As such, the multiple tiers of storage may include storage that is accessible over communications link 715. Such network accessible storage may include cloud storage or networked storage (NAS) and/or may include all or portions of a storage area network (SAN). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a computing clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 751 of FIG. 7A) to manage the interactions between the underlying hardware and user virtual machines or containers that run client software.

Distinct from user virtual machines or user executable containers, a special controller virtual machine (e.g., as depicted by controller virtual machine instance 730) or as a special controller executable container is used to manage certain storage and I/O activities. Such a special controller virtual machine is referred to as a “CVM,” or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines-above the hypervisors-thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 7D depicts a distributed virtualization system in a multi-computing cluster environment 7D00. The shown distributed virtualization system is configured to be used to implement the herein disclosed techniques. Specifically, the distributed virtualization system of FIG. 7D comprises multiple computing clusters (e.g., computing cluster 783₁, . . . , computing cluster 783_{N}) comprising multiple nodes that have multiple tiers of storage in a storage pool. Representative nodes (e.g., node 781₁₁, . . . , node 781_{1M}) and storage pool 790 associated with computing cluster 783₁ are shown. Each node can be associated with one server, multiple servers, or portions of a server. The nodes can be associated (e.g., logically and/or physically) with the computing clusters. As shown, the multiple tiers of storage include storage that is accessible through a network 796, such as a networked storage 786 (e.g., a storage area network or SAN, network attached storage or NAS, etc.). The multiple tiers of storage further include instances of local storage (e.g., local storage 791₁₁, . . . , local storage 791_{1M}). For example, the local storage can be within or directly attached to a server and/or appliance associated with the nodes. Such local storage can include solid state drives (SSD 793₁₁, . . . , SSD 793_{1M}), hard disk drives (HDD 794₁₁, . . . , HDD 794_{1M}), and/or other storage devices.

As shown, any of the nodes of the distributed virtualization system can implement one or more user virtualized entities (VEs) such as the virtualized entity (VE) instances shown as VE 788₁₁₁, . . . , VE 788_{11K}, . . . , VE 788_{1M1}, . . . , VE 788_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 787₁₁, . . . , host operating system 787_{1M}), while the VMs run multiple applications on various respective guest operating systems. Such flexibility can be facilitated at least in part by a hypervisor (e.g., hypervisor 785₁₁, . . . , hypervisor 785_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 787₁₁, . . . , host operating system 787_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 790 by the VMs and/or the executable containers.

Multiple instances of such virtualized controllers can coordinate within a computing cluster to form the distributed storage system 792 which can, among other operations, manage the storage pool 790. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 781₁₁ can interface with a controller virtual machine (e.g., virtualized controller 782₁₁) through hypervisor 785₁₁ to access data of storage pool 790. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 792. For example, a hypervisor at one node in the distributed storage system 792 might correspond to software from a first vendor, and a hypervisor at another node in the distributed storage system 792 might correspond to a second software vendor. As another virtualized controller implementation example, executable containers can be used to implement a virtualized controller (e.g., virtualized controller 782_{1M}) in an operating system virtualization environment at a given node. In this case, for example, the virtualized entities at node 781_{1M} can access the storage pool 790 by interfacing with a controller container (e.g., virtualized controller 782_{1M}) through hypervisor 785_{1M} and/or the kernel of host operating system 787_{1M}.

In certain embodiments, one or more instances of an agent can be implemented in the distributed storage system 792 to facilitate the herein disclosed techniques. Specifically, agent 784₁₁ can be implemented in the virtualized controller 782₁₁, and agent 784_{1M} can be implemented in the virtualized controller 782_{1M}. Such instances of the virtualized controller can be implemented in any node in any computing cluster. Actions taken by one or more instances of the virtualized controller can apply to a node (or between nodes), and/or to a computing cluster (or between computing clusters), and/or between any resources or subsystems accessible by the virtualized controller or their agents.

Solutions for providing infrastructure-independent scaling of hyperconverged computing nodes can be brought to bear through implementation of any one or more of the foregoing techniques. Moreover, any aspect or aspects of flexibly deploying hyperconverged infrastructure computing nodes can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts comprising:
maintaining a computing environment having a storage pool formed using a common address space across storage located on multiple computing nodes in the computing environment;
implementing a first type of computing node in the computing environment having both a virtualization storage controller and a user virtual machine (UVM), wherein the UVM interacts with the virtualization storage controller to access the storage pool; and
implementing a second type of computing node in the computing environment having the virtualization storage controller but not having any UVMs that interact with the virtualization storage controller to access the storage pool, wherein the second type of computing node is used to expand functionality of the computing environment.

2. The non-transitory computer readable medium of claim 1, wherein implementing the second type of computing node comprises allocating a cloud bare metal node and configuring storage devices of the second type of computing node into the common address space.

3. The non-transitory computer readable medium of claim 1, wherein implementing the second type of computing node comprises allocating a cloud native node and configuring storage devices of the second type of computing node into the common address space.

4. The non-transitory computer readable medium of claim 1, wherein implementing the second type of computing node comprises mapping a set of dependencies to one or more cloud provider facilities.

5. The non-transitory computer readable medium of claim 4, further comprising instructions which, when stored in memory and executed by the processor cause the processor to perform further acts of configuring the second type of computing node using a first portion of initialization code that corresponds to the one or more cloud provider facilities.

6. The non-transitory computer readable medium of claim 5, further comprising instructions which, when stored in memory and executed by the processor cause the processor to perform further acts of configuring the second type of computing node using a second portion of initialization code that corresponds to an on-premises computing cluster.

7. The non-transitory computer readable medium of claim 1, further comprising instructions which, when stored in memory and executed by the processor cause the processor to perform further acts of establishing network communications between infrastructure of a cloud provider and a hybrid cloud configurator module.

8. The non-transitory computer readable medium of claim 7 wherein the hybrid cloud configurator module carries out a computing node configuration protocol via network communications between the infrastructure of a cloud provider infrastructure and an on-premises computing cluster.

9. A method comprising:
maintaining a computing environment having a storage pool formed using a common address space across storage located on multiple computing nodes in the computing environment;
implementing a first type of computing node in the computing environment having both a virtualization storage controller and a user virtual machine (UVM), wherein the UVM interacts with the virtualization storage controller to access the storage pool; and
implementing a second type of computing node in the computing environment having the virtualization storage controller but not having any UVMs that interact with the virtualization storage controller to access the storage pool, wherein the second type of computing node is used to expand functionality of the computing environment.

10. The method of claim 9, wherein implementing the second type of computing node comprises allocating a cloud bare metal node and configuring storage devices of the second type of computing node into the common address space.

11. The method of claim 9, wherein implementing the second type of computing node comprises allocating a cloud native node and configuring storage devices of the second type of computing node into the common address space.

12. The method of claim 9, wherein implementing the second type of computing node comprises mapping a set of dependencies to one or more cloud provider facilities.

13. The method of claim 12, further comprising configuring the second type of computing node using a first portion of initialization code that corresponds to the one or more cloud provider facilities.

14. The method of claim 13, further comprising configuring the second type of computing node using a second portion of initialization code that corresponds to an on-premises computing cluster.

15. The method of claim 9, further comprising establishing network communications between infrastructure of a cloud provider and a hybrid cloud configurator module.

16. The method of claim 15 wherein the hybrid cloud configurator module carries out a computing node configuration protocol via network communications between the infrastructure of a cloud provider infrastructure and an on-premises computing cluster.

17. A system comprising:
a storage medium having stored thereon a sequence of instructions; and
a processor that executes the sequence of instructions to cause the processor to perform acts comprising,
maintaining a computing environment having a storage pool formed using a common address space across storage located on multiple computing nodes in the computing environment;
implementing a first type of computing node in the computing environment having both a virtualization storage controller and a user virtual machine (UVM), wherein the UVM interacts with the virtualization storage controller to access the storage pool; and
implementing a second type of computing node in the computing environment having the virtualization storage controller but not having any UVMs that interact with the virtualization storage controller to access the storage pool, wherein the second type of computing node is used to expand functionality of the computing environment.

18. The system of claim 17, wherein implementing the second type of computing node comprises allocating a cloud bare metal node and configuring storage devices of the second type of computing node into the common address space.

19. The system of claim 17, wherein implementing the second type of computing node comprises allocating a cloud native node and configuring storage devices of the second type of computing node into the common address space.

20. The system of claim 17, wherein implementing the second type of computing node comprises mapping a set of dependencies to one or more cloud provider facilities.

21. The system of claim 20, further comprising instructions which, when stored in memory and executed by the processor cause the processor to perform further acts of configuring the second type of computing node using a first portion of initialization code that corresponds to the one or more cloud provider facilities.

22. The system of claim 21, further comprising instructions which, when stored in memory and executed by the processor cause the processor to perform further acts of configuring the second type of computing node using a second portion of initialization code that corresponds to an on-premises computing cluster.

23. The system of claim 17, further comprising instructions which, when stored in memory and executed by the processor cause the processor to perform further acts of establishing network communications between infrastructure of a cloud provider and a hybrid cloud configurator module.

24. The system of claim 23 wherein the hybrid cloud configurator module carries out a computing node configuration protocol via network communications between the infrastructure of a cloud provider infrastructure and an on-premises computing cluster.
